(19) United States
(12) Patent Application Publication
(10) Pub. No.: US 2025/0323414 A1
(43) Pub. Date: Oct. 16, 2025

(54) Integrated Non-Terrestrial Network Direct to Device Antenna

(71) Applicant: Dell Products L.P., Round Rock, TX (US)

(72) Inventors: Erik Boch, OTTAWA (CA); Michael Healy, Scituate, MA (US); Qing Ye, Hopkinton, MA (US)

(21) Appl. No.: 18/633,339

(22) Filed: Apr. 11, 2024

(51) Int. Cl. H01Q 1/24; H01Q 3/06; H04B 1/00

(52) U.S. Cl. CPC H01Q 1/247; H01Q 3/06; H04B 1/0003

(57) ABSTRACT

A system can comprise a computing device comprising a keyboard portion and a monitor portion, wherein the keyboard portion and the monitor portion are physically coupled, and wherein the monitor portion is hingedly rotatable relative to the keyboard portion. The system can further comprise an antenna portion that is physically coupled with the monitor portion, wherein the antenna portion is hingedly rotatable relative to the monitor portion, and wherein the antenna portion comprises a non-terrestrial network direct-to-device phased array antenna that is configured to communicate with a non-terrestrial network vehicle.

### BACKGROUND

There can be terrestrial networks (TNs), and non-terrestrial networks (NTNs).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

A system can comprise a computing device comprising a keyboard portion and a monitor portion, wherein the keyboard portion and the monitor portion are coupled, and wherein the monitor portion is hingedly rotatable relative to the keyboard portion. The system can further comprise an antenna portion that is physically coupled with the monitor portion, wherein the antenna portion is hingedly rotatable relative to the monitor portion, and wherein the antenna portion comprises a non-terrestrial network direct-to-device phased array antenna that is configured to communicate with a non-terrestrial network vehicle.

An example apparatus can comprise a computing device comprising a monitor. The apparatus can further comprise an antenna that is coupled with the monitor, wherein the antenna is hingedly rotatable relative to the monitor, and wherein the antenna comprises a non-terrestrial network direct-to-device phased array antenna that is configured to communicate with a non-terrestrial network vehicle.

An example device can comprise a computer monitor. The device can further comprise an antenna that is coupled with the computer monitor, wherein the antenna is rotatable relative to the computer monitor via a hinge, and wherein the antenna is configured to communicate with a non-terrestrial network vehicle.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate an integrated non-terrestrial network direct to device antenna, in accordance with an embodiment of this disclosure;

FIG. 2 illustrates a system architecture of a non-terrestrial network operating in a transparent mode, and that can facilitate an integrated non-terrestrial network direct to device antenna, in accordance with an embodiment of this disclosure;

FIG. 3 illustrates a system architecture of a non-terrestrial network operating in a regenerative mode, and that can facilitate an integrated non-terrestrial network direct to device antenna, in accordance with an embodiment of this disclosure;

FIG. 4 illustrates an example of an antenna utilizing a single electron beam to make a connection to a non-terrestrial network satellite, and that can facilitate an integrated non-terrestrial network direct to device antenna, in accordance with an embodiment of this disclosure;

FIG. 5 illustrates an example of an antenna utilizing a single electron beam to track a non-terrestrial network satellite connection, and that can facilitate an integrated non-terrestrial network direct to device antenna, in accordance with an embodiment of this disclosure;

FIG. 6 illustrates an example of an antenna utilizing a single electron beam to make a handoff to a next non-terrestrial network satellite, and that can facilitate an integrated non-terrestrial network direct to device antenna, in accordance with an embodiment of this disclosure;

FIG. 7 illustrates an example of an antenna utilizing a dual electron (or multiple electron beams) beam, and that can facilitate an integrated non-terrestrial network direct to device antenna, in accordance with an embodiment of this disclosure;

FIG. 8 illustrates an example device with an antenna that can facilitate an integrated non-terrestrial network direct to device antenna, in accordance with an embodiment of this disclosure;

FIG. 9 illustrates an example system architecture of a notebook processor-to-fifth generation new radio (5G NR) modem air-interface logical data-path, and that can facilitate an integrated non-terrestrial network direct to device antenna, in accordance with an embodiment of this disclosure;

FIG. 10 illustrates a system architecture flow that can facilitate an integrated non-terrestrial network direct to device antenna, in accordance with an embodiment of this disclosure;

FIG. 11 illustrates another example system architecture that can facilitate an integrated non-terrestrial network direct to device antenna, in accordance with an embodiment of this disclosure;

FIG. 12 illustrates another example system architecture that can facilitate an integrated non-terrestrial network direct to device antenna, in accordance with an embodiment of this disclosure;

FIG. 13 illustrates an example block diagram of a computer operable to execute an embodiment of this disclosure.

### DETAILED DESCRIPTION

### Overview

While the examples used herein generally describe fifth generation new radio (5G NR) wireless communications protocols, it can be appreciated that the present techniques can be applied with other wireless communications protocols, such as third generation (3G), fourth generation (4G), long term evolution (LTE), and sixth generation (6G) protocols, as well as proprietary or military/para-military protocols.

Additionally, while the examples used herein generally describe low-Earth orbit (LEO) satellites, it can be appreciated that the present techniques can be applied to other types of non-terrestrial network vehicles, such as geosynchronous equatorial orbit (GEO) satellites, unmanned aerial vehicles (UAVs) providing wireless communication connectivity, or high-altitude platform stations (HAPS) providing the same.

Non-terrestrial networks (NTN) are being embraced in the mobile telecommunications industry due to the opportunity to fill in voids in terrestrial network (TN) radio frequency (RF) coverage. This opportunity to “fill in” no coverage locations can be found in providing a ubiquitous TN+NTN network across the globe.

Recently, low earth orbit (LEO) satellites have begun to process mobile network operators' (MNOs′) workloads on their LEO constellations. This migration to NTN resources can increase with a push to 6G mobile network technology, where TN and NTN merging can be agreed upon across the mobile telecommunications industry.

Prior approaches to satellite antennas for devices lack the advantages of the present techniques of an integrated non-terrestrial network direct to device antenna. The present techniques can be implemented to offer compute capability to recommend a usage of single beam mode versus a dual beam mode to improve communication performance, based on an RF signal detected by the integrated antenna.

Each satcom operator can have its own telemetry, tracking, and command (TT&C) operation bands, authorized by the Federal Communications Commission (FCC). When a laptop antenna powers up and detects RF signals from the sky (which could be from more than one operator), a laptop processor can provide signal processing to help recognize which signal is from which satcom operator, and analyze signal-to-noise ratio (SNR) to pick a better performed signal link.

Another example can be that, once a laptop, or other portable user device, is aware of the satcom operator, the satellite's constellation orbit can be known (e.g., it can be public information). The laptop can calculate the delta-t of a handoff between satellite n and satellite n+1 of the same constellation to predict a handoff and recommend single beam mode or dual beam mode to support optimal performance at that time, at that location for that laptop user. That is, the present techniques can be implemented to offer portability as well as performance.

### EXAMPLE ARCHITECTURES, ETC.

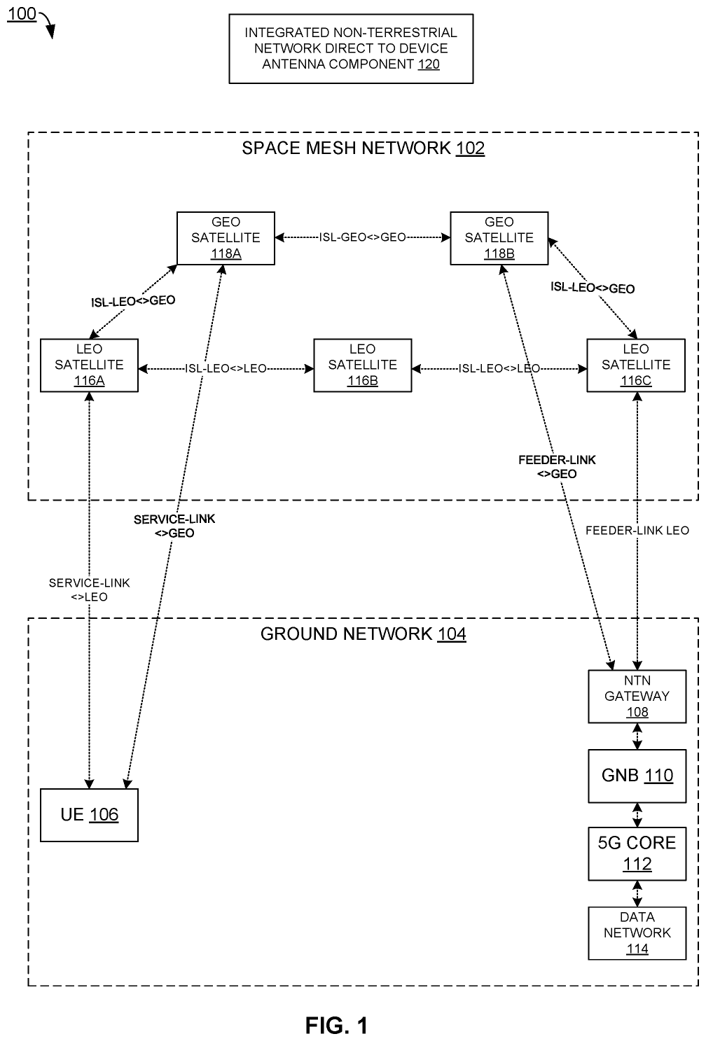

FIG. 1 illustrates an example system architecture 100 that can facilitate an integrated non-terrestrial network direct to device antenna, in accordance with an embodiment of this disclosure.

System architecture 100 comprises space mesh network 102, ground network 104, user equipment (UE) 106, NTN gateway 108, gNodeB (gNB; sometimes referred to as a base station) 110, 5G core 112, data network 114, LEO satellite 116A, LEO satellite 116B, LEO satellite 116C, GEO satellite 118A, GEO satellite 118B, and integrated non-terrestrial network direct to device antenna component 120.

NTNs can be described as “any network that flies.” An NTN architecture can support LEO/medium Earth Orbit (MEO)/geosynchronous Earth orbit (GEO) satellites, high altitude platform systems (HAPS), and unmanned aerial vehicles (UAVs).

FIG. 1 depicts a ground network and a space mesh network. The ground network can be an Internet Protocol (IP) packet network, such as using IP or Ethernet formats, and processed with routers and switches.

The space mesh network can comprise a newer, non-standardized, vendor-specific network or 3GPP standardized NTN.

In FIG. 1, the UE notebook is communicating with the LEO satellite. This can be the direct to device (D2D) technology, where commercial, off-the-shelf notebook computers can communicate directly with LEO Satellites using a 3^{rd} Generation Partnership Project (3GPP) compliant fifth generation (5G) new radio (NR) Standards Development Organization (SDO) protocol.

D2D technology can comprise facilitating normal, off-the-shelf cellphones, notebook computers, and other user equipment, in communicating directly with a satellite, providing ubiquitous coverage across the globe.

A problem with prior approaches can relate to a challenge of getting a strong, clean, high signal to noise ratio RF signal into a notebook computer, or other device. This problem can be mitigated by the present techniques.

The present techniques can be implemented to address under-served communities where no broadband access is available. An under-served, digital divide, rural broadband challenge can be enormous across the globe.

The present techniques can be implemented to include the following. The present techniques can be implemented to facilitate an integrated antenna in a notebook computer (or tablet device) that is configured to directly connect with NTN satellites (satcom). This can facilitate delivering internet access to users in rural areas with bandwidth adequate for daily operations like email, web browsing, and video conferencing, and without a need of separate user terminal hardware (e.g., mobile wireless and satcom), providing improved mobility and ease of use.

The present techniques can utilize an air interface of a 3GPP compliant 5G NR and long term evolution (LTE) (fourth generation (4G)) protocol stacks. The frequency band can be a 3GPP frequency range 1 (FR1) (Sub 6) band of 5G NR and LTE (4G) bands Using 3GPP air interfaces/bands can allow backwards compatibility with NTN satellite constellations deployed many years ago, and the present antenna technology can facilitate this connectivity.

The present techniques can reduce power usage. Some NTN satellite technologies can require large antennas on a satellite, with corresponding large power needs for the satellite. Supplying adequate power to satellites in orbit can be a challenge in space technology. Antenna technology according to the present techniques can reduce satellite antenna gain requirements, so lower-power antennas on satellites can be viable. Additionally, the present techniques can be implemented to facilitate connecting user devices with already-deployed in-orbit satellite constellations. In some examples, an implementation of the array on a laptop/tablet can increase the system gain, and therefore can enable the use of larger RF bandwidth channels, so high data capacities can be achieved.

The present techniques can facilitate a compact, integrated antenna design for a user device that can allow a user to fold an antenna back to a notebook lid surface, while also having a flexibility to rotate to certain angles to better track radio frequencies from NTN satellites (while crossing a service area). This design can include improved RF signal gain being integrated into a notebook physical structure. In examples where the antenna was external to the notebook, the RF cable losses can be significant.

Prior approaches to adding a practical antenna to a notebook computer have faced challenges. Through the years wireless fidelity (WiFi) has been a priority. This can include base 2.4/5.0 gigahertz (GHz) frequencies. Then WiFi over a 6 GHz frequency (WiFi 6E (according to an Institute of Electrical and Electronics Engineers (IEEE) 802.11ax standard)) was released.

With the recent proliferation of 3GPP 5G New Radio (NR), it can be that many notebook computers now support native terrestrial 5G NR.

Notebook computers can have several ways of supporting a 3GPP 5G NR wireless protocol, and a form factor utilized can be a next generation form factor (NGFF, also referred to as M.2) printed circuit board (PCB). A M.2 PCB can support a peripheral component interconnect (PCI) Express (PCIe) bus interface. Utilizing PCI Express can allow a 5G NR Modem to communicate directly with a computer's central processing unit (CPU). A PCIe connection can support both control plane and data plane functions.

Prior approaches lack a laptop that is integrated with an antenna that is capable of communicating with an NTN directly.

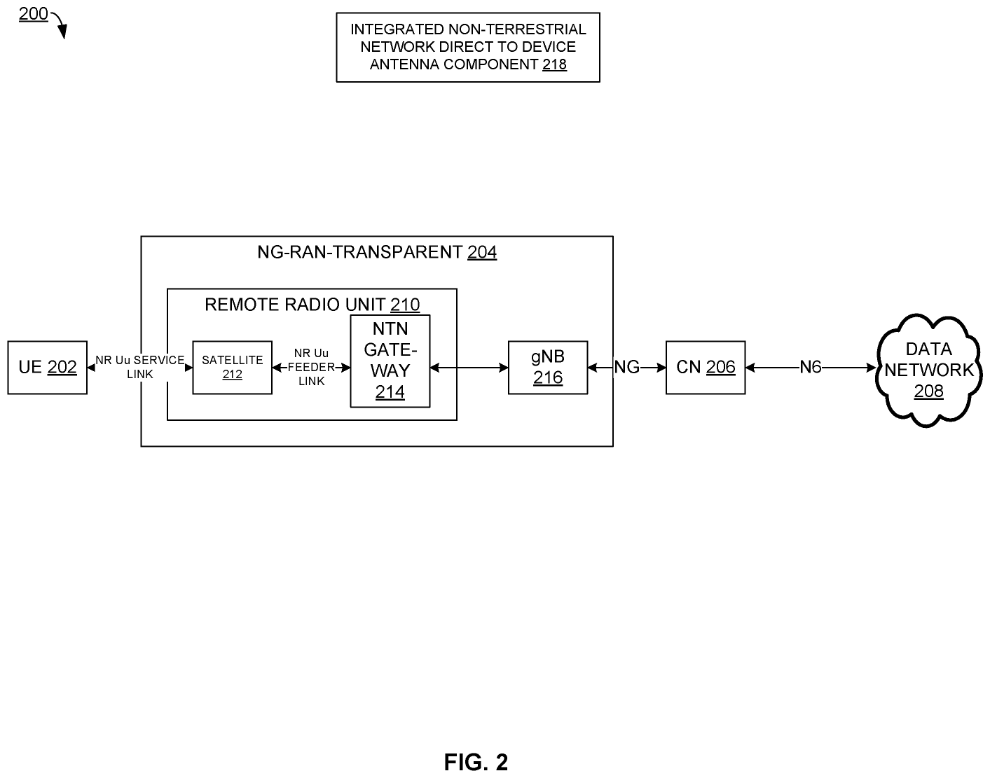

FIG. 2 illustrates a system architecture 200 of a non-terrestrial network operating in a transparent mode, and that can facilitate an integrated non-terrestrial network direct to device antenna, in accordance with an embodiment of this disclosure. In some examples, part(s) of system architecture 200 can be used by part(s) of system architecture 100 of FIG. 1 to facilitate an integrated non-terrestrial network direct to device antenna.

System architecture 200 comprises UE 202, next generation radio access network (NG-RAN) transparent 204, core network (CN) 206, data network 208, remote radio unit 210, satellite 212, NTN gateway 214, gNB 216, and integrated non-terrestrial network direct to device antenna component 218.

3GPP can define standards to support interoperability between satcom operators and 4G/5G operators. NR-NTN normative specifications can describe two architectures: transparent mode and regenerative mode.

In a transparent architecture, a satellite payload can implement radio unit (RU) functions such as frequency conversion and RF amplification, acting as a radio relay. Both a service link and a feeder link can use an NR air (Uu) interface. This can allow different satcoms to connect the same gNodeB (gNB) on the ground.

It can be that, in a transparent NG-RAN architecture, a satellite acts as an RF relay, and only includes a radio unit (RU).

An NTN can be implemented as follows, and can illustrate a ground-to-satellite communication link, and can be used in NTN transparent mode and regenerative mode topologies.

It can be that prior satellites now in orbit were not designed for connecting through a true global space mesh network. It can be that these deployed/in-orbit satellites were deployed over a decade ago, before a space mesh network was conceived. The present techniques can be implemented to connect a satellite to a satellite utilizing a global space mesh network.

A 3GPP transparent mode data flow can include:
service link: UE to satellite radio frequency communication link;
feeder link: satellite to NTN gateway radio frequency communication link;
satellite payload implements uplink/downlink frequency conversion and frequency amplification, but no demodulation of the radio frequency carrier (bent pipe mode); and
traditional satellite radio interface (SRI) NR Uu (that is, the satellite does not terminate the 5G NR protocol stack).

An air interface can include:
NTN mode (transparent mode, regen mode (A/B), proprietary);
L1 physical interface;
service link/feeder link;
bands (TN, NTN, shared);
service link/feeder link frequency;
antenna technology;
UE and NTN gateway/satellite;
physical constraints;
interference, weather, scintillation, channel modeling, link budget analysis;
use case/market/protocol (e.g., IoT, NB IoT (4G/LTE), redcap, 5G NR); and
packet format/tunneled packet (e.g., 3GPP general packet radio service (GPRS) tunneling protocol (GTP) tunnel, internet protocol (IP), user datagram protocol (UDP), proprietary).

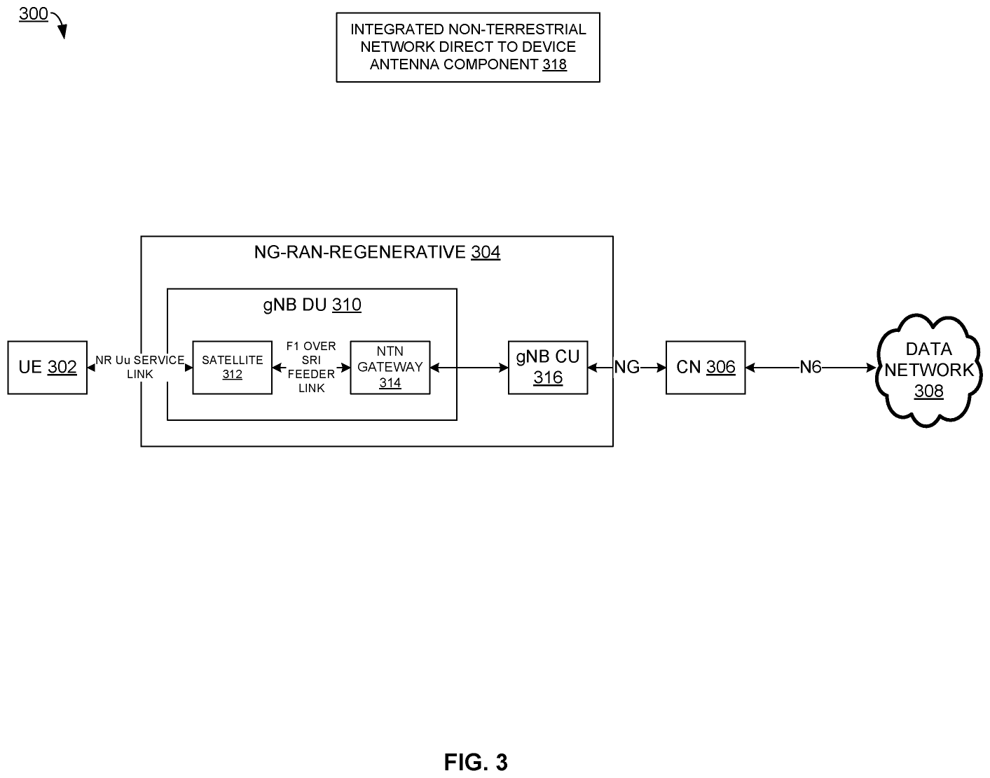

FIG. 3 illustrates a system architecture 300 of a non-terrestrial network operating in a regenerative mode, and that can facilitate an integrated non-terrestrial network direct to device antenna, in accordance with an embodiment of this disclosure. In some examples, part(s) of system architecture 300 can be used by part(s) of system architecture 100 of FIG. 1 to facilitate an integrated non-terrestrial network direct to device antenna.

System architecture 300 comprises UE 302, NG-RAN regenerative 304, CN 306, data network 308, gNB distributed unit (DU) 310, satellite 312, NTN gateway 314, gNB central unit (CU) 316, and integrated non-terrestrial network direct to device antenna component 318.

In a regenerative architecture, a satellite payload can implement part of or a full gNB to offer additional radio resource management functions (relative to a transparent architecture) such as modulation/demodulation, encoding/decoding, switch and/or routing. The service link can still use an NR Uu interface while the feeder link can use a 3GPP F1 interface over the satcom's non-standard satellite radio interface (SRI). This can allow different gNBs on a satellite to connect to the same 5G core network on the ground.

In a regenerative NG-RAN architecture, a satellite can host part of or a full gNB (where an RU and a DU are located on a satellite, CU could be located on a satellite or stay with a ground gateway).

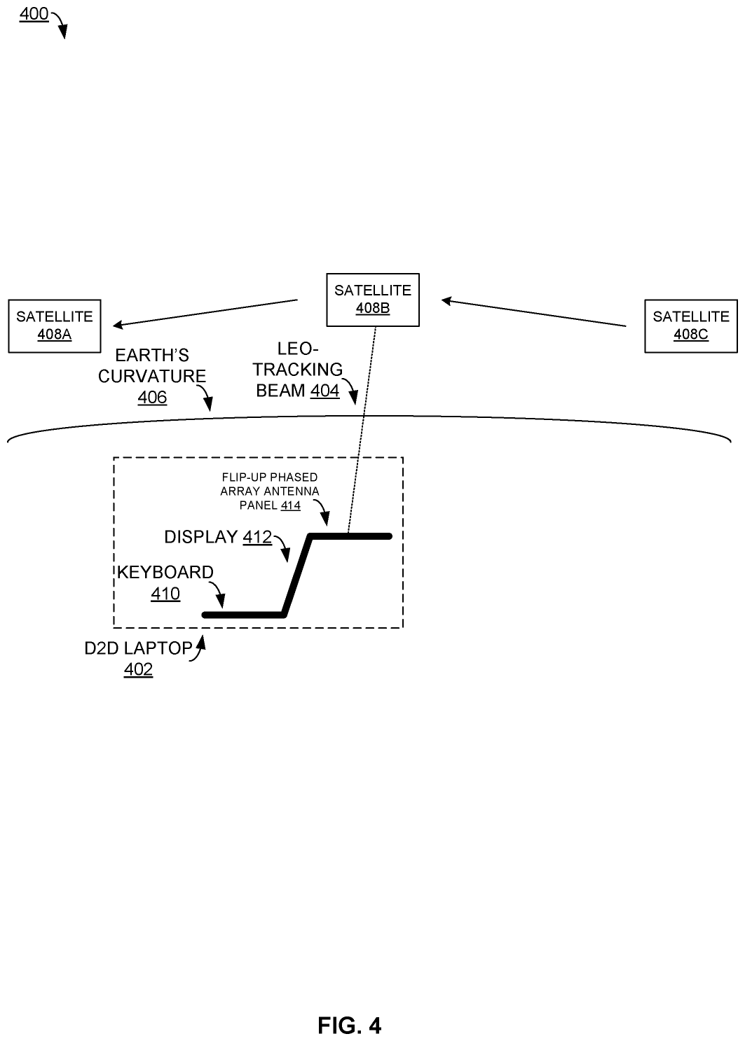

FIG. 4 illustrates an example 400 of an antenna utilizing a single electron beam to make a connection to a non-terrestrial network satellite, and that can facilitate an integrated non-terrestrial network direct to device antenna, in accordance with an embodiment of this disclosure. In some examples, part(s) of example 400 can be used by part(s) of system architecture 100 of FIG. 1 to facilitate an integrated non-terrestrial network direct to device antenna.

System architecture 400 comprises D2D laptop 402, LEO-tracking beam 404, Earth's curvature 406, satellite 408A, satellite 408B, and satellite 408C. In turn, D2D laptop 402 comprises keyboard 410, display 412, and flip-up phased array antenna panel 414.

Examples of the present techniques can include single electron beam and dual electron beam embodiments, to facilitate an integrated notebook computer that can access NTN satellites directly.

A single electron beam example can be implemented as follows.

In a first step, a connection can be made to a LEO NTN satellite. A phased array can create a single beam that acquires a satellite and tracks it across the satellite's overhead path.

Different satellite constellations can have different characteristics. For instance, the satellites of different constellations can be spaced differently, or can operate at different altitudes.

In some examples, the present techniques can be used to switch between satellite constellations, such as by finding a new constellation in a different latitude.

A user device according to the present techniques can know which constellation it is connected to. In some examples, an antenna can vary its latitude without moving the antenna, such as by 20 degrees in either direction.

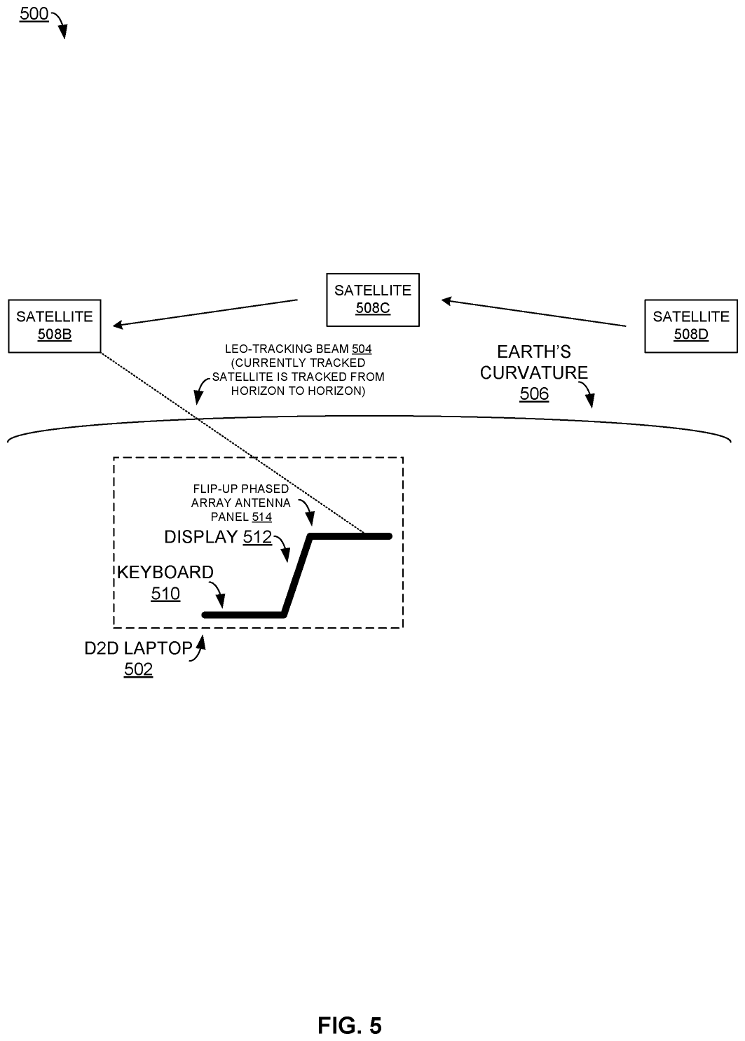

FIG. 5 illustrates an example 500 of an antenna utilizing a single electron beam to track a non-terrestrial network satellite connection, and that can facilitate an integrated non-terrestrial network direct to device antenna, in accordance with an embodiment of this disclosure. In some examples, part(s) of example 500 can be used by part(s) of system architecture 100 of FIG. 1 to facilitate an integrated non-terrestrial network direct to device antenna.

System architecture 500 comprises D2D laptop 502, LEO-tracking beam 504, Earth's curvature 506, satellite 508B, satellite 508C, and satellite 508D. In turn, D2D laptop 502 comprises keyboard 510, display 512, and flip-up phased array antenna panel 514.

In a second step (relative to FIG. 4), LEO satellite connections can be tracked. A single beam can track a LEO satellite across its path. A single LEO can be “visible” for approximately 1-5 minutes, depending on geo-location and constellation design.

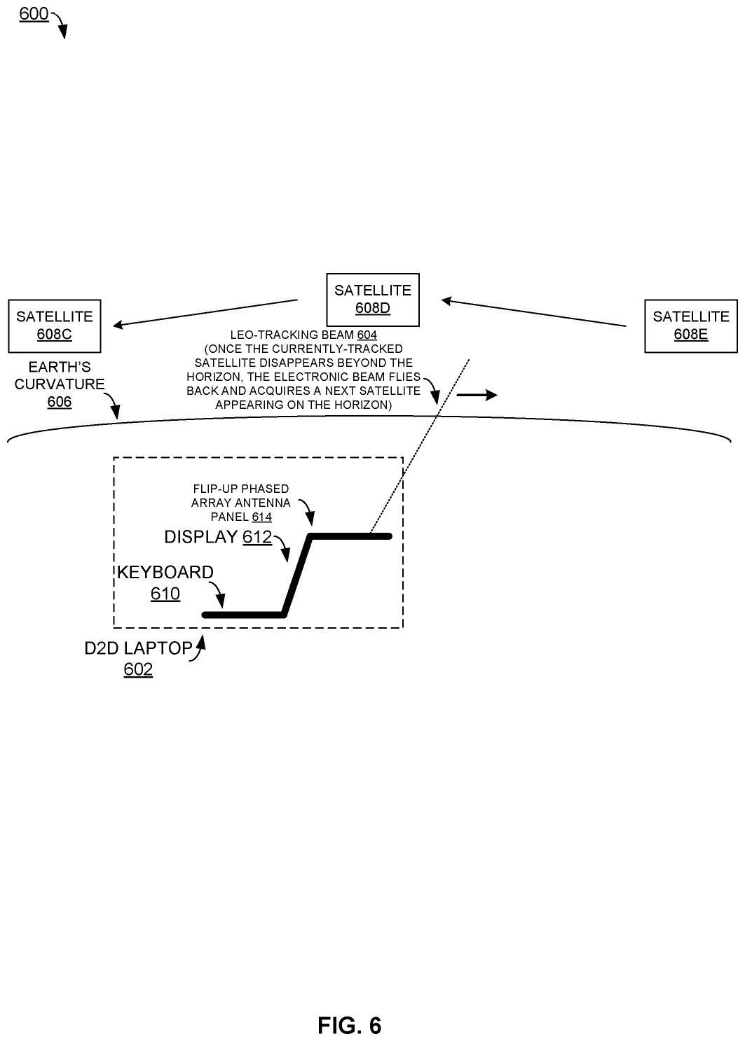

FIG. 6 illustrates an example 600 of an antenna utilizing a single electron beam to make a handoff to a next non-terrestrial network satellite, and that can facilitate an integrated non-terrestrial network direct to device antenna, in accordance with an embodiment of this disclosure. In some examples, part(s) of example 600 can be used by part(s) of system architecture 100 of FIG. 1 to facilitate an integrated non-terrestrial network direct to device antenna.

System architecture 600 comprises D2D laptop 602, LEO-tracking beam 604, Earth's curvature 606, satellite 608C, satellite 608D, and satellite 608E. In turn, D2D laptop 602 comprises keyboard 610, display 612, and flip-up phased array antenna panel 614.

In a third step (relative to FIGS. 4-5), a handoff can be made to a next LEO NTN satellite. A single beam can “fly back” to a tracking horizon and acquire a next satellite appearing in the satellite constellation. “Flying back” and acquiring a next satellite in a constellation can require time, which can lead to a discontinuity in connectivity.

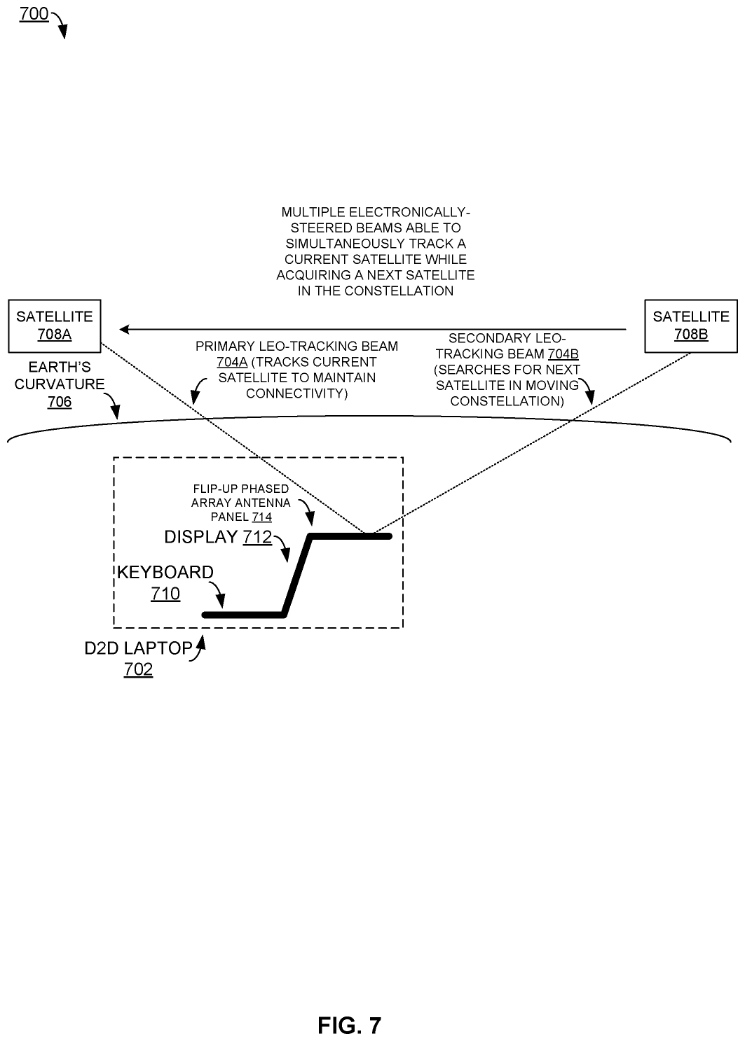

FIG. 7 illustrates an example 700 of an antenna utilizing a dual electron beam (or multiple electron beams), and that can facilitate an integrated non-terrestrial network direct to device antenna, in accordance with an embodiment of this disclosure. In some examples, part(s) of example 700 can be used by part(s) of system architecture 100 of FIG. 1 to facilitate an integrated non-terrestrial network direct to device antenna.

System architecture 700 comprises D2D laptop 702, primary LEO-tracking beam 704A, secondary LEO-tracking beam 704B, Earth's curvature 706, satellite 708A, and satellite 708B. In turn, D2D laptop 702 comprises keyboard 710, display 712, and flip-up phased array antenna panel 714.

A dual electron beam concept can be implemented as follows. Multiple electronically steerable beams can independently track a current satellite while acquiring a next satellite in a (moving) constellation). This approach can avoid a dead time associated with “flying back” and acquisition in a single beam example, and can provide a near-continuous connectivity that can be needed for many applications.

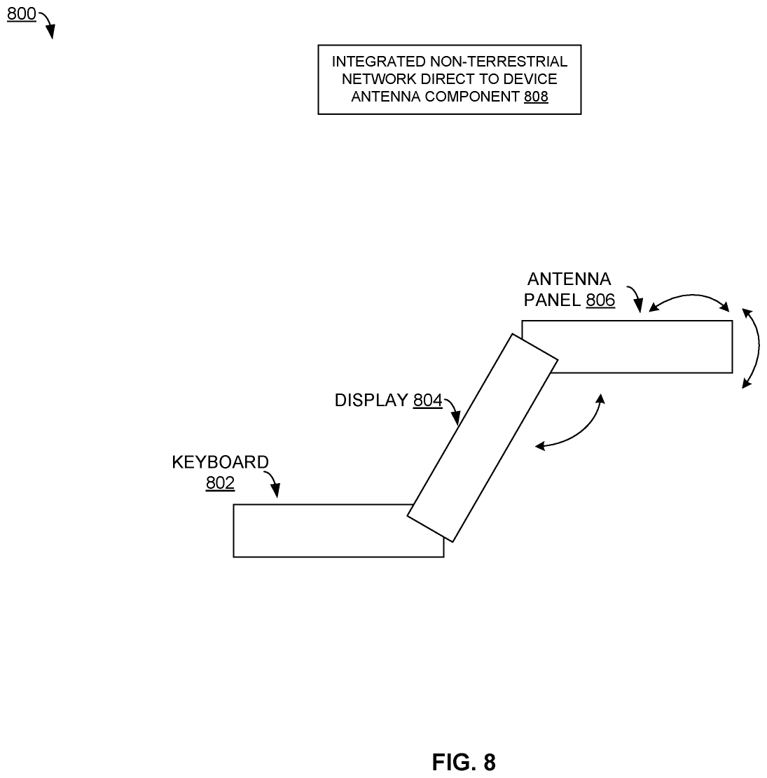

FIG. 8 illustrates an example device 800 with an antenna that can facilitate an integrated non-terrestrial network direct to device antenna, in accordance with an embodiment of this disclosure. In some examples, part(s) of device 800 can be used by part(s) of system architecture 100 of FIG. 1 to facilitate an integrated non-terrestrial network direct to device antenna.

Device 800 comprises keyboard 802, display 804, antenna panel 806, and integrated non-terrestrial network direct to device antenna component 808.

An antenna can be mechanically implemented as follows. An antenna panel can be roughly the size of a notebook computer, e.g., 35 centimeters (cm) by 30 cm. A hinge can allow an antenna to fold back to a display from a horizontal position facing the sky for compactness. This can also allow the antenna panel to tilt and/or rotate—for example by +/−30 degrees to better align with a satellite beam when there is a blockage directly above the antenna.

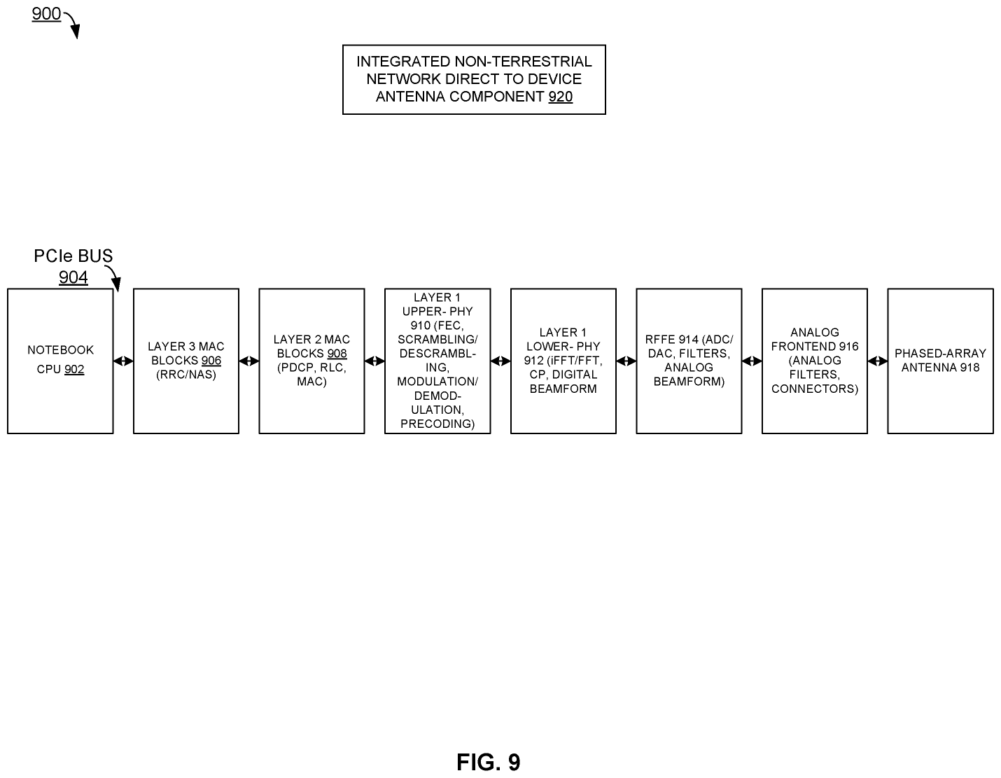

FIG. 9 illustrates an example system architecture 900 of a notebook processor-to-fifth generation new radio (5G NR) modem air-interface logical data-path, and that can facilitate an integrated non-terrestrial network direct to device antenna, in accordance with an embodiment of this disclosure. In some examples, part(s) of system architecture 900 can be used by part(s) of system architecture 100 of FIG. 1 to facilitate an integrated non-terrestrial network direct to device antenna.

System architecture 900 comprises notebook CPU 902, Peripheral Component Interconnect Express (PCIe) bus 904, Layer 3 medium access control (MAC) blocks 906 (radio resource control (RRC)/non-access stratum (NAS)), Layer 2 MAC blocks 908 (packet data convergence protocol (PDCP), radio link control (RLC), MAC), Layer 1 upper-physical (PHY) 910 (forward error correction (FEC), scrambling, modulation, precoding), Layer 1 lower-PHY 912 (Fast Fourier Transform (FFT), Inverse Fast Fourier Transform (iFFT), cyclic prefix (CP), digital beamform), RF front end (RFFE) 914 (analog-to-digital converter/digital-to-analog converter (ADC/DAC), filters, analog beamforming (BF)), analog frontend 916 (analog filters, connectors), phased-array antenna 918, and integrated non-terrestrial network direct to device antenna component 920.

Where a 5G modem is integrated into a notebook computer, it can be that a user does not rely solely on WiFi or wired connections. Rather, users can access the internet from virtually anywhere, receiving RF signals from TN or NTN directly. In some examples, RF signals can travel from a phased-array antenna according to the present techniques to a notebook CPU, through different vendors' 5G NR modems. A logical block can control an RF signal through L3/L2/L1.

Flat panel antenna gain experiments and results can be as follows. In an example, a ˜35 cm by 35 cm phased array panel can be used to directly connect to user equipment on the ground. This can be approximately the same size as a laptop lid.

Where an antenna is larger than a typical laptop lid, a phased array can be folded, and then extended when it is in use, depending on its mechanical design.

In terms of data speed, such an antenna can be in a range of a D2D laptop use case. For instance, speeds of 190 megabytes per second (Mbps) download and 20 Mbps upload can be observed while switching beams every 11 seconds and switching satellites every 3 minutes. An average round trip latency in this example can be approximately 55 milliseconds (ms).

The following examples can illustrate how a link budget can be adequate to form a D2D connection. In a first example, a satellite at a 517 kilometers (km) orbit can make a two-way direct connection with an LTE phone using 850 MHz as a service link frequency, a maximum LTE speed of 10.3 Mb/second(s), a maximum 5G speed of 14 Mb/s. This link budget can tolerate an uplink (UL) free-space path loss (FSPL) of 145.31 decibels (dB) using an LTE phone antenna with a gain of less than 5 dB.

In a second example, a satellite at a 340 km orbit can make a two-way direct connection with an unmodified LTE phone using 1.9 GHz as a service link frequency. A link budget can tolerate an UL FSPL of 149.08 dB using an LTE phone antenna with a gain of less than 5 dB.

In a third example, a LEO constellation can be located at 1,200 km, and this constellation can close its link budget and connect to user equipment to deliver broadband satcom.

The present techniques can be implemented to facilitate using a device with an antenna gain of higher than the example of less than 5 dB.

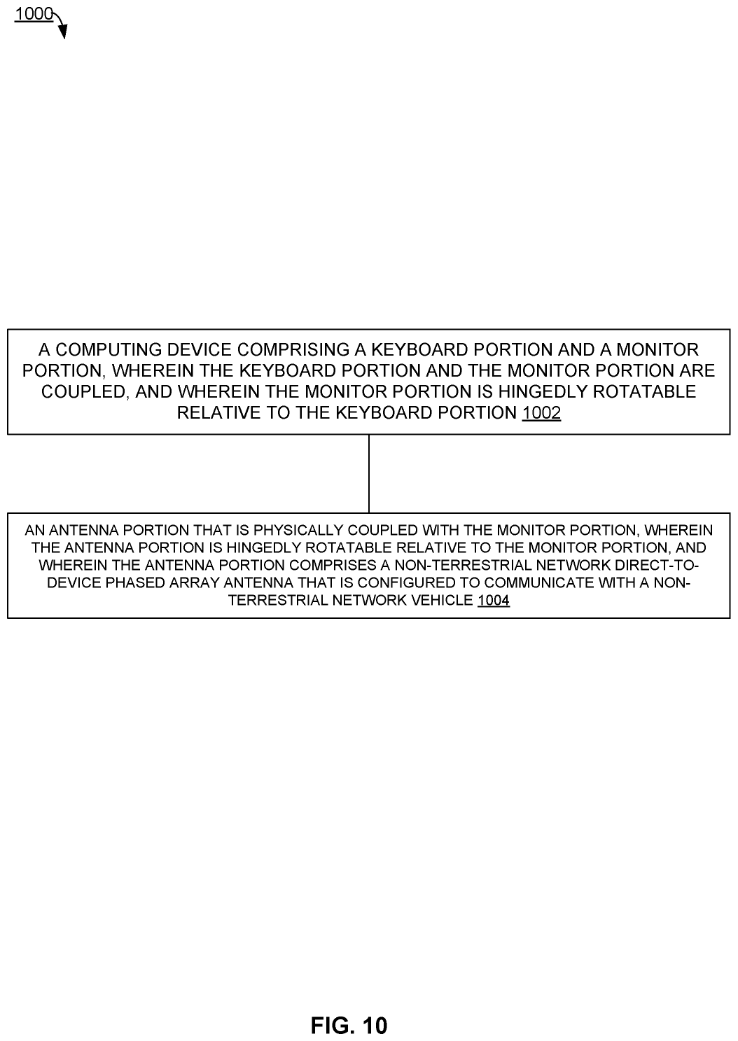

FIG. 10 illustrates a system architecture 1000 of a computing device that can facilitate an integrated non-terrestrial network direct to device antenna, in accordance with an embodiment of this disclosure. In some examples, part(s) of system architecture 1000 can be used by part(s) of system architecture 100 of FIG. 1 to facilitate an integrated non-terrestrial network direct to device antenna.

System architecture 1000 comprises a computing device comprising a keyboard portion and a monitor portion, wherein the keyboard portion and the monitor portion are coupled, and wherein the monitor portion is hingedly rotatable relative to the keyboard portion 1002, and an antenna portion that is physically coupled with the monitor portion, wherein the antenna portion is hingedly rotatable relative to the monitor portion, and wherein the antenna portion comprises a non-terrestrial network direct-to-device phased array antenna that is configured to communicate with a non-terrestrial network vehicle 1004.

In some examples, the keyboard is a physical keyboard. In other examples, the keyboard is a virtual keyboard.

In some examples, the antenna portion is configured to form an electron beam to communicate with the non-terrestrial network vehicle. This can be a single electron beam example, and/or a dual electron beam example.

In some examples, the non-terrestrial network vehicle is a first non-terrestrial network vehicle, a constellation of non-terrestrial network vehicles comprises the first non-terrestrial network vehicle, and the antenna portion is configured to, terminate a first communication with the first non-terrestrial network vehicle, and after terminating the first communication, initiate a second communication with a second non-terrestrial network vehicle of the constellation of non-terrestrial network vehicles. In some examples, initiating the second communication with the second non-terrestrial network vehicle comprises moving the electron beam toward a tracking horizon and toward the second non-terrestrial network vehicle. That is, a single electron beam example can switch from one satellite to another. The single beam can attempt to maintain a continuous, uninterrupted communication between an earth component and a space/satellite component.

In some examples, the electron beam is a first electron beam, the non-terrestrial network vehicle is a first non-terrestrial network vehicle, a constellation of non-terrestrial network vehicles comprises the first non-terrestrial network vehicle, and the antenna portion is configured to, initiate a second communication with a second non-terrestrial network vehicle of the constellation of non-terrestrial network vehicles using a second electron beam, and while the antenna portion is communicating with the first non-terrestrial network vehicle using the first electron beam. In some examples, the antenna portion is configured to initiate a third communication with a third non-terrestrial network vehicle of the constellation of non-terrestrial network vehicles using a third electron beam, while the antenna portion is communicating with the second non-terrestrial network vehicle using the second electron beam, and after the antenna portion has ceased communicating with the first non-terrestrial network vehicle using the first electron beam. This can be a dual electron beam example.

In some examples, an air interface of the antenna portion comprises a third generation partnership project-compliant fifth generation new radio direct to device protocol stack or a satellite communication direct to device protocol stack. This can be a 3GPP-compliant 5G NR D2D protocol stack, or a satcom D2D protocol stack.

In some examples, a frequency band of the air interface comprises a third generation partnership project frequency range 1 (sub-6) band of a fifth generation new radio band. This can be a 3GPP range 1 (sub-6) band of a 5G NR band.

In some examples, an air interface of the antenna portion comprises a third generation partnership project-compliant long term evolution protocol stack. This can be a 3GPP-compliant LTE protocol stack.

In some examples, a frequency band of the air interface comprises a third generation partnership project frequency range 1 (sub-6) band of a long term evolution band. This can be a 3GPP frequency range 1 (sub-6) band of an LTE band.

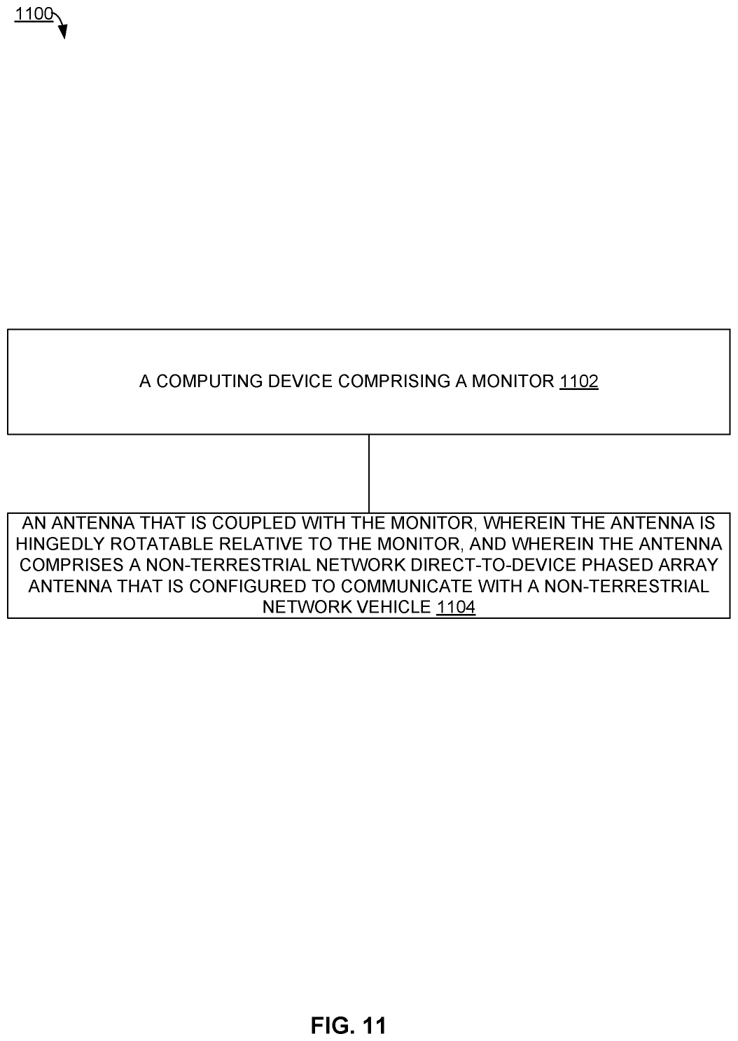

FIG. 11 illustrates another example system architecture 1100 of an apparatus that can facilitate an integrated non-terrestrial network direct to device antenna, in accordance with an embodiment of this disclosure. In some examples, part(s) of system architecture 1100 can be used by part(s) of system architecture 100 of FIG. 1 to facilitate an integrated non-terrestrial network direct to device antenna.

System architecture 1100 comprises a computing device comprising a monitor 1102, and an antenna that is coupled with the monitor, wherein the antenna is hingedly rotatable relative to the monitor, and wherein the antenna comprises a non-terrestrial network direct-to-device phased array antenna that is configured to communicate with a non-terrestrial network vehicle 1104.

In some examples, the antenna is physically coupled to the monitor. In other examples, a detachable antenna can be removed from the monitor and placed separately on a flat/near-flat surface. In such examples, the antenna can communicate with the rest of the system via a wired or wireless communications channel.

In some examples, a first planar surface area of the monitor is substantially similar to a second planar surface area of the antenna. That is, the antenna's length and width can be about the same as the back of the monitor.

In some examples, the antenna is configured to communicate with the non-terrestrial network vehicle according to a third generation partnership protocol standards development organization protocol or a satellite communication air interface. This can be a 3GPP SDO protocol, or a satcom air interface.

In some examples, the antenna is configured to rotate relative to the monitor via a hinge, and wherein the antenna is configured to be rotated such that a first planar surface of the antenna is substantially touching a second planar surface of the monitor. That is, the antenna can fold out from the back of the monitor.

In some examples, the antenna is configured to maintain position relative to the monitor at a group of angles between a first planar surface of the antenna and a second planar surface of the monitor. That is, the antenna can be folded out to various positions, and can hold those positions.

In some examples, the antenna is hingedly rotatable relative to the monitor via a hinge, and wherein the hinge is located at a top position of the monitor when the apparatus is positioned on a flat surface. That is, the antenna can fold “up” while maintaining contact with the top of the back of the monitor via a hinge.

In some examples, the antenna is hingedly rotatable relative to the monitor via a first axis of rotation, and wherein the antenna is hingedly rotatable relative to the monitor via a second axis of rotation. That is, the antenna can fold out from the monitor, and then fold to the left or the right (relative to the monitor).

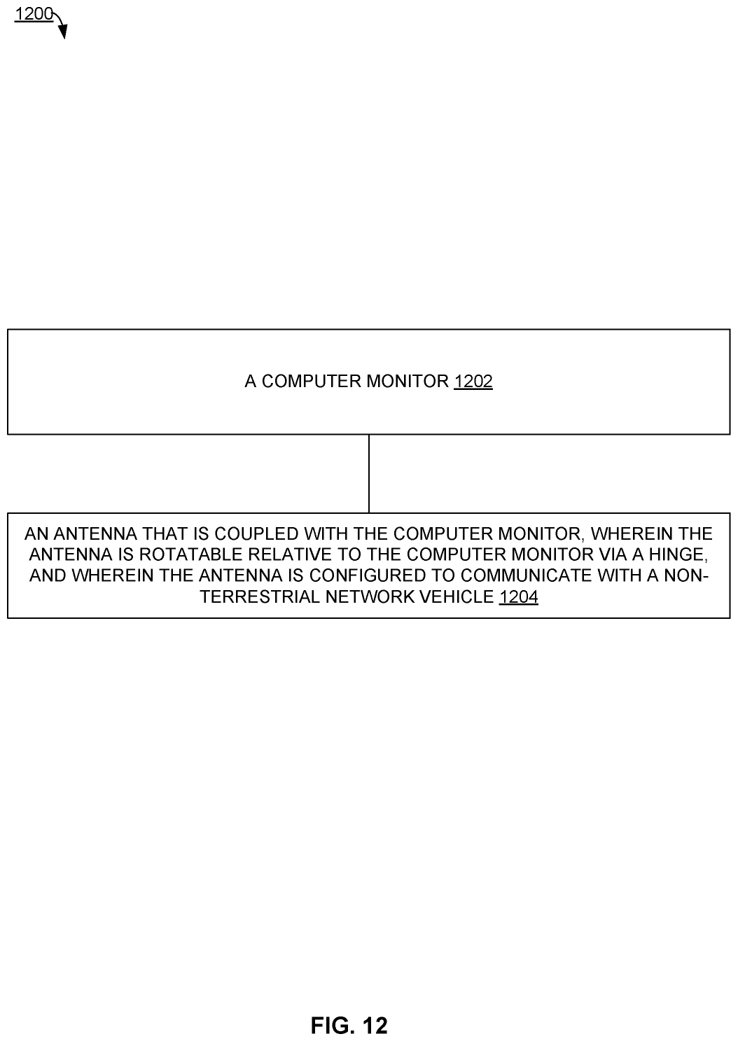

FIG. 12 illustrates another example system architecture 1200 of a device that can facilitate an integrated non-terrestrial network direct to device antenna, in accordance with an embodiment of this disclosure. In some examples, part(s) of system architecture 1200 can be used by part(s) of system architecture 100 of FIG. 1 to facilitate an integrated non-terrestrial network direct to device antenna.

System architecture 1200 comprises a computer monitor 1202, an antenna that is coupled with the computer monitor, wherein the antenna is rotatable relative to the computer monitor via a hinge, and wherein the antenna is configured to communicate with a non-terrestrial network vehicle 1204.

In some examples, system architecture 1200 further comprises a computer, and a central processing unit of the computer is configured to operate the antenna. This can be similar to as illustrated with respect to FIG. 9.

In some examples, system architecture 1200 further comprises a computer comprising a processor, and wherein a software-defined radio of the device comprises the processor, a modem, and electronics of the antenna. That is, a software-defined radio (SDR) can be formed by a CPU, a modem, and the antenna's electronics.

### Example Operating Environment

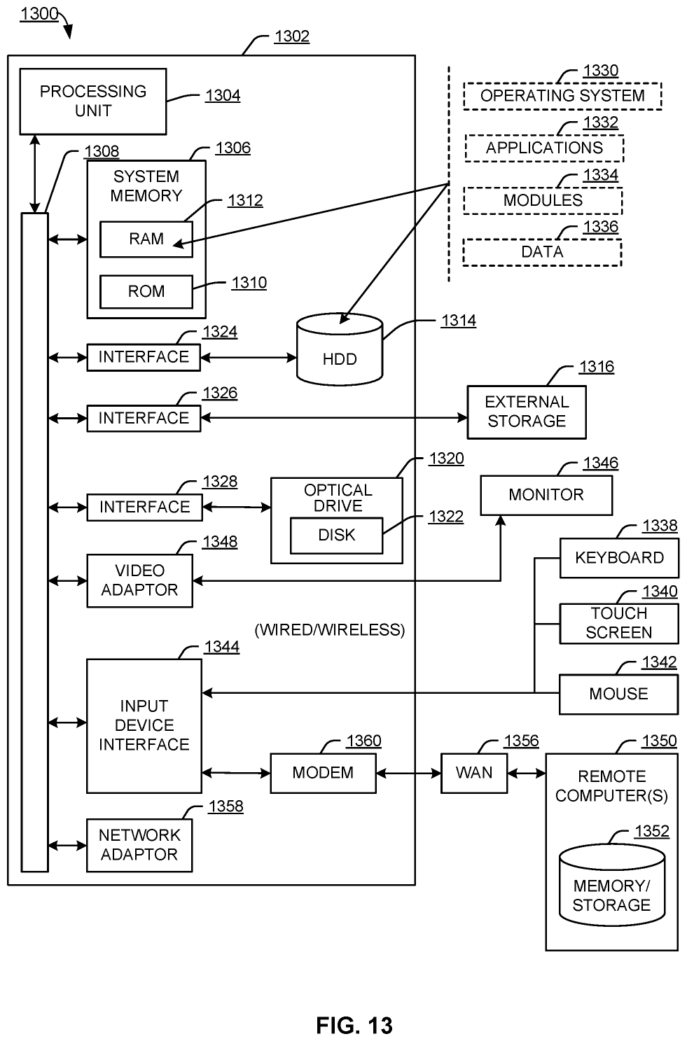

In order to provide additional context for various embodiments described herein, FIG. 13 and the following discussion are intended to provide a brief, general description of a suitable computing environment 1300 in which the various embodiments of the embodiment described herein can be implemented.

For example, parts of computing environment 1300 can be used to implement one or more embodiments of the system architectures of FIGS. 1-3 and/or 9-12 to facilitate an integrated non-terrestrial network direct to device antenna.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media. With reference again to FIG. 13, the example environment 1300 for

implementing various embodiments described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a nonvolatile storage such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), one or more external storage devices 1316 (e.g., a magnetic floppy disk drive (FDD) 1316, a memory stick or flash drive reader, a memory card reader, etc.) and an optical disk drive 1320 (e.g., which can read or write from a CD-ROM disc, a DVD, a BD, etc.). While the internal HDD 1314 is illustrated as located within the computer 1302, the internal HDD 1314 can also be configured for external use in a suitable chassis (not shown). Additionally, while not shown in environment 1300, a solid state drive (SSD) could be used in addition to, or in place of, an HDD 1314. The HDD 1314, external storage device(s) 1316 and optical disk drive 1320 can be connected to the system bus 1308 by an HDD interface 1324, an external storage interface 1326 and an optical drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are examples, and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system comprising:
a computing device comprising a keyboard portion and a monitor portion, wherein the keyboard portion and the monitor portion are coupled, and wherein the monitor portion is hingedly rotatable relative to the keyboard portion; and
an antenna portion that is physically coupled with the monitor portion,
wherein the antenna portion is hingedly rotatable relative to the monitor portion, and
wherein the antenna portion comprises a non-terrestrial network direct-to-device phased array antenna that is configured to communicate with a non-terrestrial network vehicle.

2. The system of claim 1, wherein the antenna portion is configured to form an electron beam to communicate with the non-terrestrial network vehicle.

3. The system of claim 2, wherein the non-terrestrial network vehicle is a first non-terrestrial network vehicle, wherein a constellation of non-terrestrial network vehicles comprises the first non-terrestrial network vehicle, and wherein the antenna portion is configured to,
terminate a first communication with the first non-terrestrial network vehicle, and
after terminating the first communication, initiate a second communication with a second non-terrestrial network vehicle of the constellation of non-terrestrial network vehicles.

4. The system of claim 3, wherein initiating the second communication with the second non-terrestrial network vehicle comprises moving the electron beam toward a tracking horizon and toward the second non-terrestrial network vehicle.

5. The system of claim 2, wherein the electron beam is a first electron beam, wherein the non-terrestrial network vehicle is a first non-terrestrial network vehicle, wherein a constellation of non-terrestrial network vehicles comprises the first non-terrestrial network vehicle, and wherein the antenna portion is configured to,
initiate a second communication with a second non-terrestrial network vehicle of the constellation of non-terrestrial network vehicles using a second electron beam, and while the antenna portion is communicating with the first non-terrestrial network vehicle using the first electron beam.

6. The system of claim 5, wherein the antenna portion is configured to initiate a third communication with a third non-terrestrial network vehicle of the constellation of non-terrestrial network vehicles using a third electron beam, while the antenna portion is communicating with the second non-terrestrial network vehicle using the second electron beam, and after the antenna portion has ceased communicating with the first non-terrestrial network vehicle using the first electron beam.

7. The system of claim 1, wherein an air interface of the antenna portion comprises a third generation partnership project-compliant fifth generation new radio direct to device protocol stack or a satellite communication direct to device protocol stack.

8. The system of claim 7, wherein a frequency band of the air interface comprises a third generation partnership project frequency range 1 (sub-6) band of a fifth generation new radio band.

9. The system of claim 1, wherein an air interface of the antenna portion comprises a third generation partnership project-compliant long term evolution protocol stack.

10. The system of claim 7, wherein a frequency band of the air interface comprises a third generation partnership project frequency range 1 (sub-6) band of a long term evolution band.

11. An apparatus, comprising:
a computing device comprising a monitor; and
an antenna that is coupled with the monitor, wherein the antenna is hingedly rotatable relative to the monitor, and wherein the antenna comprises a non-terrestrial network direct-to-device phased array antenna that is configured to communicate with a non-terrestrial network vehicle.

12. The apparatus of claim 11, wherein a first planar surface area of the monitor is substantially similar to a second planar surface area of the antenna.

13. The apparatus of claim 11, wherein the antenna is configured to communicate with the non-terrestrial network vehicle according to a third generation partnership protocol standards development organization protocol or a satellite communication air interface.

14. The apparatus of claim 11, wherein the antenna is configured to rotate relative to the monitor via a hinge, and wherein the antenna is configured to be rotated such that a first planar surface of the antenna is substantially touching a second planar surface of the monitor.

15. The apparatus of claim 11, wherein the antenna is configured to maintain position relative to the monitor at a group of angles between a first planar surface of the antenna and a second planar surface of the monitor.

16. The apparatus of claim 11, wherein the antenna is hingedly rotatable relative to the monitor via a hinge, and wherein the hinge is located at a top position of the monitor when the apparatus is positioned on a flat surface.

17. The apparatus of claim 11, wherein the antenna is hingedly rotatable relative to the monitor via a first axis of rotation, and wherein the antenna is hingedly rotatable relative to the monitor via a second axis of rotation.

18. A device, comprising:
a computer monitor; and
an antenna that is coupled with the computer monitor, wherein the antenna is rotatable relative to the computer monitor via a hinge, and wherein the antenna is configured to communicate with a non-terrestrial network vehicle.

19. The device of claim 18, wherein the device further comprises a computer, and wherein a central processing unit of the computer is configured to operate the antenna.

20. The device of claim 18, wherein the device further comprises a computer comprising a processor, and wherein a software-defined radio of the device comprises the processor, a modem, and electronics of the antenna.
